(19) United States
(12) Patent Application Publication
(10) Pub. No.: US 2022/0384888 A1
(43) Pub. Date: Dec. 1, 2022

(54) FIXING OF BUSBARS IN A WELDING PROCESS

(71) Applicant: WEBASTO SE, Stockdorf (DE)

(72) Inventor: Volker Boehringer, Stockdorf (DE)

(21) Appl. No.: 17/752,134

(22) Filed: May 24, 2022

(30) Foreign Application Priority Data
May 25, 2021 (DE) 102021113487.0

(51) Int. Cl. H01M 50/213; H01M 50/505; H01M 50/516; H02G 5/00

(52) U.S. Cl. CPC H01M 50/213; H01M 50/505; H01M 50/516; H02G 5/00; H01M 2220/20

(57) ABSTRACT

A cell holder for holding cylindrical battery cells in a battery module for forming a high-voltage battery, for example a traction battery for a vehicle, includes a positioning element that is configured to position a busbar for contacting battery cells held in the cell holder.

### CROSS-REFERENCE TO RELATED APPLICATIONS

This application claims priority from German Patent Application No. DE 10 2021 113 487.0, filed on May 25, 2021 in the German Patent and Trademark Office, the disclosure of which is incorporated herein by reference in its entirety.

### BACKGROUND

### Technical Field

The present invention relates to a cell holder for holding cylindrical battery cells in a battery module for forming a high-voltage battery, for example a traction battery for a vehicle, a busbar for contacting cylindrical battery cells held in a cell holder in a battery module for forming a high-voltage battery, for example a traction battery for a vehicle, and a method for connecting a busbar to a cell holder. The high-voltage battery can be used, for example, to provide propulsion energy for an electric drive of a vehicle for transporting people and/or goods.

### Related Art

High-voltage batteries are known from the prior art, the battery cells of which are connected to busbars, also known as current collectors. The batteries are also called accumulators. These are usually electrochemical accumulators, especially lithium-ion accumulators. Such batteries are usually not constructed as a monobloc, but as a modular system consisting of multiple battery cells that are mechanically and electrically connected to each other. For the construction of a battery system in an electric vehicle, it is accordingly known to arrange battery cells in battery modules and to assemble these to form a battery. This increases the configurability of batteries and allows the use of comparatively inexpensive standard battery cells in the construction of batteries.

For the purposes of the present disclosure, a battery cell is understood to be an electrochemical storage cell, and in some embodiments, a secondary cell. The term “cell” can be understood with regard to the physical appearance of the component as the smallest structural unit that can be contacted. By contrast, a battery module is understood to be a structural unit which combines a plurality of battery cells. Accordingly, a battery is understood to be a structural unit that is constructed from one or more interconnected battery modules. Such batteries can comprise a housing receiving the battery modules and can also comprise electrical circuits as well as a battery management system. A plurality of batteries can be interconnected to form a battery system, for example to provide an increased capacity of the battery system.

The battery or battery system is, in one or more embodiments, intended for use in an electric vehicle, but can also be used in other vehicles or other fields of application.

It is also known from the prior art that if busbars are welded directly to battery cells, busbars are pre-formed accordingly so that the portions of the busbar intended for connection to the cells contact the cells in order to be welded to the latter. Pre-forming is an additional manufacturing step.

### SUMMARY

An improved cell holder and a busbar, by means of which the construction of a battery module for forming a high-voltage battery is simplified, as well as a corresponding method, are described herein according to various embodiments. herein.

Accordingly, a cell holder for holding cylindrical battery cells in a battery module for forming a high-voltage battery, for example a traction battery for a vehicle, is proposed. According to the invention, the cell holder comprises a positioning element, which is configured to position a busbar for contacting battery cells held in the cell holder.

A “positioning element” is understood in the present context to be an element formed as an integral part of a component, for example a cell holder, or a separate component, which serves to position and/or orient a busbar relative to the cell holder which comprises the positioning element.

The fact that the cell holder comprises a positioning element makes it possible to position a busbar with respect to the cell holder without the aid of additional holders or bonded connections and in particular without further manufacturing steps, in such a way that the busbar is correctly positioned and/or oriented with respect to the battery cells received in the cell holder. This enables a simplified and more precise assembly of cell holder and busbar when building a battery module for a high-voltage battery.

Due to the correct orientation of the busbar with respect to the battery cells received in the cell holder, a simplified welding of the busbar to the contacts of the battery cells can be carried out in a subsequent step, since the busbar is already oriented relative to the battery cells.

The positioning element of the cell holder can be formed as a pin that can position the busbar in at least one spatial plane. A “spatial plane” as used herein may refer, for example, to a plane that extends parallel to a surface of the cell holder suitable for receiving the busbar. A positioning element can be designed to prevent the busbar from moving in the spatial plane once it has been placed on the cell holder, or rather the surface of the cell holder. The positioning element makes it possible to prevent the busbar from shifting with respect to the cell holder. Therefore, no external fixing means or holding devices are required to position and/or orient the busbar with respect to a battery cell held in the cell holder. In several embodiments, the positioning takes place in such a way that the busbar is already positioned with respect to a plurality, or all battery cells received in the corresponding cell holder, in such a way that welding can be carried out without having to reposition the busbar when forming each welding spot.

Furthermore, the positioning element allows the busbar to be welded directly to the battery cells received in the cell holder. This is because the positioning element, which can be received in a receiving element of the busbar, positions the busbar with respect to cells held in the cell holder, in such a way that welding of the busbar to a battery cell is made possible without further fixing means.

The positioning element also allows a battery module to be assembled more quickly. This is because the positioning element eliminates additional manufacturing steps when positioning the busbars in relation to the battery cells held by the cell holder. This includes, for example, fixing the busbar to the cell holder by means of adhesive or clip connections or, for example, hot caulking the two components. Therefore, a positionally accurate welding of the busbar to the cells held by the cell holder can be performed. The positioning element can therefore allow faster and/or more reliable manufacture of a battery module for high-voltage batteries.

For example, the positioning element can be configured to allow a blocking of movement of the busbar relative to the cell holder in at least one direction in the spatial plane. In other words, the positioning element can prevent movement of the busbar relative to the cell holder in at least one direction in the spatial plane. For example, a positioning element can have a shape that allows a blocking of rotation in a spatial plane of the busbar relative to the cell holder. In other words, a positioning element can prevent rotation (in a spatial plane) of the busbar relative to the cell holder.

A cell holder can comprise one or more positioning elements. For example, the at least one positioning element can make it possible to prevent a displacement of the busbar relative to the cell holder when the at least one positioning element of the cell holder engages in the at least one receiving element of the busbar, for example when welding a battery cell to the busbar.

For example, the positioning element can be designed to position the busbar in a horizontal spatial plane. A horizontal spatial plane as used herein can refer, for example, to a horizontal plane parallel to a surface of the cell holder suitable for receiving a busbar in the case of a battery module assembled or installed in a horizontal orientation. The positioning element can be designed to allow blocking of movement of the busbar relative to the cell holder in at least one direction in the horizontal spatial plane. For example, two or more positioning elements, which can be comprised by the cell holder, can position and/or orient a busbar in a horizontal spatial plane such that movement of the busbar relative to directions in the horizontal spatial plane is prevented or inhibited. Two or more positioning elements can allow rotation of the busbar with respect to a horizontal spatial plane to be omitted or prevented.

Furthermore, a busbar for contacting cylindrical battery cells held in a cell holder in a battery module for forming a high-voltage battery is provided according to various embodiments.

Accordingly, a busbar for contacting cylindrical battery cells held in a cell holder in a battery module for forming a battery module for constructing a high-voltage battery, for example a traction battery for a vehicle, is proposed. According to the invention, the busbar comprises a receiving element which is configured to receive a positioning element of the cell holder for positioning the busbar relative to the cell holder.

The busbar can be made of a flat material. For example, the busbar can be made of a flat and non-pre-formed material. For example, the receiving element can be configured such that the received positioning element forms a mechanically fixed connection together with the receiving element. A contacting connection of the busbar, which is to be welded to a battery cell, can for example be pressed onto the battery cell by mechanical force, for example by means of a welding head, and welded there.

For example, the receiving element associated with the positioning element can take up this mechanical force and allow positioning of the busbar relative to the cell holder (and to the battery cell) to be maintained. Accordingly, as a result of the busbar, contacting connections of the busbar for contacting a battery cell do not need to be pre-formed and/or pre-bent by a manufacturing step. With fewer manufacturing steps for a busbar, faster assembly of a high-voltage battery can be made possible.

The busbar can be made of aluminium. In certain embodiments, the busbar can be made of aluminium with a thickness of 0.1 mm to 0.5 mm, for example 0.3 mm. Accordingly, the component stiffness of the busbar may be low. This allows, for example, a welding head to press a contacting connection of the busbar down onto a battery cell so that the contacting connection, when in contact with the battery cell, can be welded to the battery cell. This eliminates the need to pre-form the busbar and allows a flat, stamped material to be used.

A battery module can comprise a cell holder and a busbar as described above. Advantageously, it is possible to manufacture a battery module comprising a cell holder according to the invention and a busbar according to the invention more quickly.

In addition, a method for connecting a busbar to a cell holder is provided herein according to various embodiments.

Accordingly, a method for connecting a busbar to a cell holder is proposed. According to the invention, the method comprises bringing together a positioning element of a cell holder and a receiving element of a busbar for positioning the busbar with respect to the cell holder, for example in a spatial plane.

In the sense of the present disclosure, a spatial plane is understood to be a plane that extends with respect to a surface of the cell holder on which the busbar is to be placed. A spatial plane can also be normal to the surface of the cell holder.

For example, the positioning by the positioning element can reduce or prevent a relative movement of a busbar that has received the positioning element with its receiving element, so that a busbar does not need to be fixed further for a further step of forming a battery module for a high-voltage battery.

The method can further comprise holding down the busbar with at least one hold-down device. For example, holding down can allow a busbar to be temporarily fixed for a further manufacturing step in addition to the mechanical connection of the positioning element of the cell holder and the receiving element of the busbar, for example for welding the contacting connection to a battery cell. Further, the method can comprise pressing a contacting connection for contacting a battery cell onto a battery cell. For example, holding down can allow the busbar to be held in its position in addition to the mechanical connection of the positioning element of the cell holder and receiving element of the busbar, so that the busbar cannot tilt relative to the cell holder when a contacting connection is pressed onto a battery cell.

The method can further comprise welding the contacting connection to the battery cell. Welding can, for example, allow the contacting connection of the busbar to be permanently connected to the battery cell. Such a connection can allow the busbar to be held in a vertical direction, for example in a direction normal to a receiving surface of the cell holder for a busbar. In other words, welding can eliminate the need for further fixing of the busbar, or of the contacting connections, in a vertical direction. According to the invention, the method can eliminate the need for the use of adhesive or clip connections, for example inserting clips and removing clips or gluing, in order to fix the busbar relative to the cell holder.

In other words, by means of the proposed cell holder by means of the proposed busbar, as well as by means of the proposed method, it is possible to dispense with additional fixings of the busbars when constructing a battery module for a high-voltage battery.

In all of the above embodiments, a battery can comprise a single battery module, or a plurality of battery modules.

### BRIEF DESCRIPTION OF THE FIGURES

Further embodiments of the invention are explained in more detail by the following description of the figures.

FIG. 1 shows a schematic perspective view of a detail of a battery module for a high-voltage battery with cell holder, busbar, battery cells and positioning element as well as receiving element;

FIG. 2 shows schematic side views of cell holders with a positioning element, as well as schematic plan views of the cell holders with the corresponding positioning elements;

FIG. 3 shows a schematic plan view of a busbar with different designs of receiving elements; and

FIG. 4 shows a schematic representation of a method for connecting a busbar to a cell holder.

### DETAILED DESCRIPTION

In the following, exemplary embodiments are described on the basis of the figures. In this context, identical, similar or similarly acting elements are provided with identical reference signs in the different figures, and a repeated description of these elements is partially omitted in order to avoid redundancies.

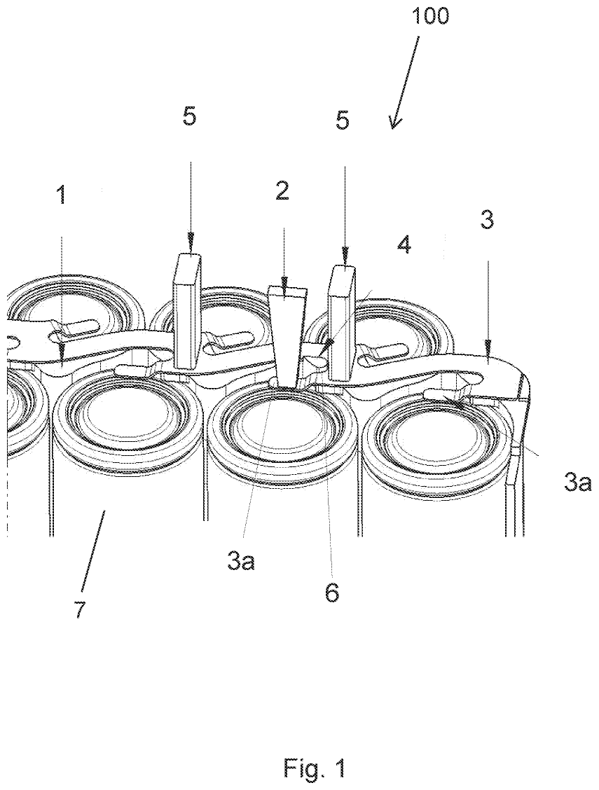

FIG. 1 shows a schematic perspective view of a detail of a battery module 100 for a high-voltage battery which has a cell holder 1, a busbar 3, battery cells 7 and a positioning element 4 as well as a receiving element 6. Furthermore, two hold-down devices 5 and a welding head 2 are shown schematically as examples. The hold-down devices 5 hold down the busbar 3 here as an example, so that the welding head 2 can weld a contacting connection 3a to one of the battery cells 7. In the process, the busbar 3, which is made of flat material, is pressed down by the welding head 2 onto the contacting surface of the corresponding battery cell 7 and welded. The welding is sufficient to hold the busbar 3 and to provide sufficient contacting.

The contacting connections 3a at the rear in perspective in the figure are shown here as already welded, the contacting connections 3a at the front in perspective are shown here by way of example in a partially pressed-down position. A welding head 2 is shown here only as an example for pressing down a contacting connection 3a before the actual welding. For example, one or more contacting connections can be pressed down or welded at the same time.

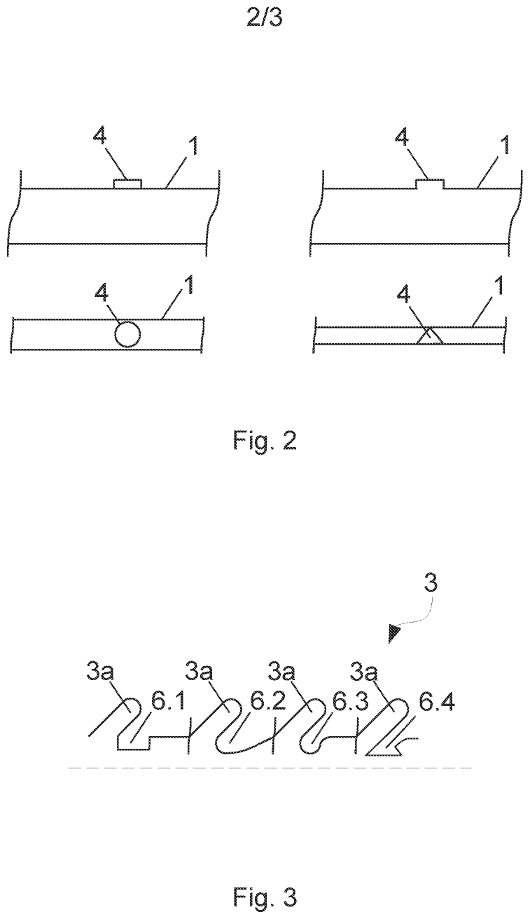

FIG. 2 shows schematic front views of cell holders 1 in the upper part of the figure. In the lower part of the figure, the corresponding plan views of the cell holders 1 located above are shown. The cell holders 1 each comprise a positioning element 4. The left-hand illustration of a cell holder 1 shows an example of a positioning element 4, which is round in a plan view and is embodied as a separate component.

A positioning element 4, which is embodied as a separate component, can, for example, be connected to the cell holder 1 in an interlocking and/or integrally bonded manner. The exemplary illustration on the left side in FIG. 2 schematically shows a positioning element 4 which can secure a positioning of a busbar with corresponding receiving element relative to the cell holder 4 in a spatial plane. A spatial plane is here, for example, parallel to the upper edge of the cell holder 1 shown above (left) in FIG. 2. A rotation of the busbar around the positioning element 4 cannot be prevented with the positioning element 4 shown here as an example due to its rotational symmetry. For example, two or more positioning elements can be included in the cell holder 1, so that rotation of the busbar about an axis of rotation normal to the receiving surface of the cell holder 1 is prevented.

The exemplary illustration on the right-hand side in FIG. 2 schematically shows a cell holder 1 with integrated positioning element 1 in a front view (top) and a plan view (bottom). The positioning element 4 shown here as an example is embodied as a polygon. In a plan view, a positioning element can have a geometric shape, such as a triangle, quadrilateral or polygon. A positioning element can have a geometric shape in a plan view, such as a circle, an ellipse or the like. The positioning element can have this shape as a separate component or can be an integral part of the cell holder. For example, a positioning element can be configured to prevent rotation of a receiving element about an axis of the positioning element. If a cell holder comprises at least two positioning elements, it can be made possible, for example, to prevent rotation of the receiving element (of the busbar) in a horizontal spatial plane.

FIG. 3 shows, by way of example, a plurality of designs of receiving elements 6.1 to 6.4 of a busbar 3 with contacting connections 3a. These various exemplary designs of receiving elements are each shown separated by a vertical wavy line. The dashed line indicates that only a part of a busbar is shown and the other part is not shown. Receiving elements 6.1 to 6.4 are each configured so that a positioning element corresponding to the shape of the corresponding receiving element (6.1 to 6.4) can be received.

The receiving element 6.1, as shown in FIG. 3, can for example receive a positioning element with a rectangular cross-section in a plan view. Receiving elements 6.2 and 6.3 can, for example, receive a positioning element as shown on the left side in FIG. 2. For example, the exemplary receiving element 6.4 can receive the positioning element shown on the right side of FIG. 2. Other forms of receiving elements are not excluded herewith.

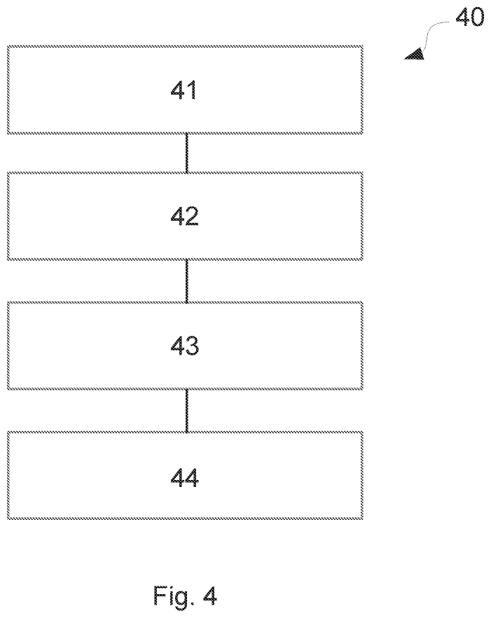

FIG. 4 shows a schematic representation of a method 40 for connecting a busbar to a cell holder. For example, the method 40 can comprise bringing together 41 a positioning element of a cell holder and a receiving element of a busbar to position the busbar with respect to the cell holder. In one or more embodiments, positioning the positioning element of a cell holder and a receiving element of a busbar to position the busbar with respect to the cell holder refers to a positioning in a spatial plane.

By way of example, the method further comprises holding down 42 the busbar with at least one hold-down device, pressing 43 a contacting connection for contacting a battery cell onto a battery cell, and welding 44 the contacting connection to the battery cell. The method 40 can further comprise pressing 43 the contacting connection onto a battery cell using a welding head.

As far as applicable, all individual features shown in the exemplary embodiments can be combined and/or interchanged without departing from the scope of the invention.

What is claimed is:

1. A cell holder for holding cylindrical battery cells in a battery module for forming a high-voltage battery comprising:
a positioning element that is configured to position a busbar, wherein the busbar is configured to contact the cylindrical battery cells held in the cell holder.

2. The cell holder of claim 1, wherein the positioning element is formed as a pin that is configured to position the busbar in at least one spatial plane.

3. The cell holder of claim 1, wherein the positioning element is configured to position the busbar in a horizontal spatial plane.

4. The cell holder of claim 1, wherein the positioning element has a shape configured to block rotation in at least one direction in a spatial plane relative to the cell holder.

5. The cell holder of claim 1, wherein the positioning element is formed as an integral part of the cell holder.

6. The cell holder of claim 1, wherein the positioning element is formed as a separate component of the cell holder.

7. The cell holder of claim 1, wherein the high-voltage battery comprises a traction battery for a vehicle.

8. A battery module comprising the cell holder of claim 1.

9. A busbar for contacting cylindrical battery cells held in a cell holder in a battery module for forming a high-voltage battery comprising: contacting connections configured to contact the cylindrical battery cells; and
a receiving element configured to receiving a positioning element of the cell holder, wherein the positioning element is configured to position the busbar relative to the cell holder.

10. The busbar of claim 9, wherein the busbar comprises a flat material.

11. The busbar of claim 9, wherein the busbar comprises aluminum.

12. The busbar of claim 11, wherein the aluminum has a thickness of about 0.1 mm to about 0.5 mm.

13. The busbar of claim 12, wherein the aluminum has a thickness of 0.3 mm.

14. The busbar of claim 9, wherein the high-voltage battery comprises a traction battery for a vehicle.

15. A battery module comprising the busbar of claim 9.

16. A method for connecting a busbar to a cell holder, comprising:
bringing together a positioning element of the cell holder and a receiving element of the busbar, wherein the positioning element is configured to position the busbar with respect to the cell holder.

17. The method of claim 16, wherein the positioning element is further configured to position the busbar in a spatial plane.

18. The method of claim 16, further comprising:
holding down the busbar with at least one hold-down device;
pressing a contacting connection of the busbar to contact a battery cell; and
welding the contacting connection to the battery cell.

19. The method of claim 18, wherein the contacting connection is pressed onto the battery cell via a welding head.

20. A battery module formed by the method of claim 16, comprising:
the cell holder; and
the busbar.
